(19) United States
(12) Patent Application Publication
(10) Pub. No.: US 2023/0182722 A1
(43) Pub. Date: Jun. 15, 2023

(54) COLLISION AVOIDANCE METHOD AND APPARATUS

(71) Applicant: HYUNDAI MOBIS Co., Ltd., Seoul (KR)

(72) Inventor: Ge O PARK, Seoul (KR)

(73) Assignee: HYUNDAI MOBIS Co., Ltd., Seoul (KR)

(21) Appl. No.: 17/883,951

(22) Filed: Aug. 9, 2022

(30) Foreign Application Priority Data
Dec. 14, 2021 (KR) 10-2021-0178464

(51) Int. Cl. B60W 30/09; B60W 40/072; B60W 60/00

(52) U.S. Cl. CPC B60W 30/09; B60W 40/072; B60W 60/0015; B60W 2554/40

(57) ABSTRACT

A collision avoidance method and apparatus are provided. The collision avoidance method includes sensing a forward vehicle and a lane of a front road, receiving global positioning system (GPS) information and vehicle specification information from the forward vehicle, generating a virtual lane corresponding to the forward vehicle upon failing to the lane of the front road, and performing a control operation to avoid collision with the forward vehicle based on the generated virtual lane.

Pursuant to 35 U.S.C. § 119(a), this application claims the benefit of Korean Patent Application No. 10-2021-0178464, filed on Dec. 14, 2021, which is hereby incorporated by reference as if fully set forth herein.

### BACKGROUND OF THE DISCLOSURE

### Field of the Disclosure

The present embodiments are applicable to vehicles of all fields and, more particularly, to various systems that derive collision avoidance of an autonomous driving vehicle in correspondence to forward vehicles.

### Discussion of the Related Art

The Society of Automotive Engineers (SAE) of the America defines six levels of vehicle autonomy ranging from Level 0 to Level 5 as follows.

Level 0 (No-Automation). The driver is completely responsible for controlling everything related to driving. The driver always drives, and a vehicle system performs only auxiliary functions such as emergency alert. A subject of driving control is the human, and the human is also responsible for detecting variables that occur while driving and for driving.

Level 1 (Driver Assistance). The system assists the driver through adaptive cruise control and lane keeping functions. The system is activated to assist the driver in keeping the speed of the vehicle, a distance between vehicles, and a lane. A subject of driving control is the human and the system. All the responsibilities for detecting variables that occur while driving and for driving lie on the human.

Level 2 (Partial Automation). The vehicle and the human can simultaneously control steering and acceleration/deceleration of the vehicle for a period of time under certain conditions. The vehicle may perform assistant driving that steers at a gentle curve and maintains a distance from a forward vehicle. However, the human has the responsibility for detecting variables during driving and for driving. The driver always needs to monitor a driving environment and should immediately intervene in driving in a situation of which the system is not aware.

Level 3 (Conditional Autonomous). The system is in charge of driving in certain conditions, such as on highways, and the driver intervenes only in the case of danger. The system is responsible for driving control and variable detection during driving. Unlike level 2, the driver does not require monitoring of the driving environment. However, the system makes a request to the driver for immediate intervention in the case of exceeding requirements of the system.

Level 4 (High Automation). The vehicle can operate in an autonomous driving mode on most roads. The system has all the responsibilities for driving control and driving. Driver intervention is unnecessary on most roads except for restricted situations. However, since driver intervention may be requested under certain conditions such as in bad weather, a driving control device by the human is required.

Level 5 (Full Automation). The vehicle does not require a driver and can be driven only by an occupant. The occupant only need enter a destination, and the system is responsible for driving under all conditions. In the level 5, control devices for steering, acceleration, and deceleration of the vehicle are unnecessary.

However, in an autonomous driving system known up to date, when a lane and a forward vehicle are invisible or missing due to deteriorating weather conditions or external factors, a function of preventing an autonomous driving vehicle from colliding with a nearby vehicle by implementing a virtual vehicle and a virtual lane has not been developed.

### SUMMARY

Accordingly, the present disclosure is directed to a method and an apparatus for collision avoidance that substantially obviate one or more problems due to limitations and disadvantages of the related art.

An embodiment of the present disclosure is to provide a collision avoidance apparatus for implementing a virtual lane using a global positioning system (GPS), a navigation system, and vehicle information.

Another embodiment of the present disclosure is to provide a collision avoidance apparatus for displaying a generated virtual lane to the exterior through a hologram.

Another embodiment of the present disclosure is to provide a system for preventing an accident with other nearby vehicles by causing a vehicle to travel in a virtual lane.

The objects to be achieved by the present disclosure are not limited to what has been particularly described hereinabove and other objects not described herein will be more clearly understood by persons skilled in the art from the following detailed description.

To achieve these objects and other advantages and in accordance with the purpose of the disclosure, as embodied and broadly described herein, a collision avoidance method includes sensing, by a sensor, a forward vehicle and a lane of a front road, receiving, by a communicator, global positioning system (GPS) information and vehicle specification information from the forward vehicle, generating, by a processor, a virtual lane corresponding to the forward vehicle upon failing to detect the lane of the front road, and performing, by the processor, a control operation to avoid collision with the forward vehicle based on the generated virtual lane.

According to an embodiment of the present disclosure, the generating the virtual lane corresponding to the forward vehicle may include generating, by the processor, a virtual vehicle corresponding to the forward vehicle based on the GPS information and the vehicle specification information upon failing to detect the lane of the front road, and generating, by the processor, the virtual lane based on the generated virtual vehicle.

According to an embodiment of the present disclosure, the generating the virtual lane based on the generated virtual vehicle may include generating, by the processor, the virtual lane based on a width of a lane in which the virtual vehicle is traveling and an entire width of the virtual vehicle.

According to an embodiment of the present disclosure, the collision avoidance method may further include receiving, by the processor, the GPS information and the vehicle specification information from each of a plurality of forward vehicles based on presence of the plurality of forward vehicles, generating, by the processor, a plurality of virtual vehicles corresponding to the plurality of forward vehicles, respectively, and generating, by the processor, a plurality of virtual lanes corresponding to the plurality of generated virtual vehicles, respectively.

According to an embodiment of the present disclosure, the collision avoidance method may further include determining, by the processor, whether the plurality of virtual lanes are straight lanes.

According to an embodiment of the present disclosure, the collision avoidance method may further include generating, by the processor, virtual lanes of an entire road by fusing the plurality of virtual lanes, based on the plurality of virtual lanes being the straight lanes.

According to an embodiment of the present disclosure, the collision avoidance method may further include disregarding, by the processor, non-straight virtual lanes when some of the plurality of virtual lanes are not straight lanes, and generating, by the processor, virtual lanes of an entire road by fusing a plurality of virtual lanes except for the disregarded virtual lanes.

According to an embodiment of the present disclosure, the collision avoidance method may further include receiving, by the processor, curvature information of the front road, and generating, by the processor, the virtual lane in correspondence to the curvature information.

According to an embodiment of the present disclosure, the collision avoidance method may further include generating, by the processor, a hologram based on the generated virtual lane, and outputting, by an output unit, the generated hologram to a front and a rear of a vehicle.

In another aspect of the present disclosure, a recording medium storing a collision avoidance program is provided. The collision avoidance program causes a computer to sense a forward vehicle and a lane of a front road receive global positioning system (GPS) information and vehicle specification information from the forward vehicle, generate a virtual lane corresponding to the forward vehicle, upon failing to detect the lane of the front road, and perform a control operation to avoid collision with the forward vehicle based on the generated virtual lane.

In another aspect of the present disclosure, a collision avoidance apparatus includes a sensor configured to sense a forward vehicle and a lane of a front road, a communicator configured to receive global positioning system (GPS) information and vehicle specification information from the forward vehicle, a navigation system configured to provide map information of the front road, and a processor configured to generate a virtual lane corresponding to the forward vehicle, upon failing to detect the lane of the front road, and perform a control operation to avoid collision with the forward vehicle based on the generated virtual lane.

In another aspect of the present disclosure, an autonomous driving vehicle includes at least one sensor configured to sense a forward vehicle and a lane of a front road, and a collision avoidance apparatus configured to generate a virtual lane corresponding to the forward vehicle, upon failing to detect the lane of the front road, and perform a control operation to avoid collision with the forward vehicle based on the generated virtual lane.

According to any one of embodiments of the present disclosure, a collision avoidance apparatus capable of preventing an accident with other nearby vehicles even when an autonomous driving vehicle fails to properly see a forward vehicle due to nearby vehicles is provided.

According to any one of embodiments of the present disclosure, a collision avoidance apparatus capable of accurately estimating presence/absence of a nearby vehicle and a movement route of the nearby vehicle is provided.

The effects that are achievable by the present disclosure are not limited to what has been particularly described hereinabove and other advantages not described herein will be more clearly understood by persons skilled in the art from the following description.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is an overall block diagram of an autonomous driving control system to which an autonomous driving apparatus according to any one of embodiments of the present disclosure is applicable;

FIG. 2 is a diagram illustrating an example in which an autonomous driving apparatus according to any one of embodiments of the present disclosure is applied to a vehicle;

FIG. 3 is a block diagram illustrating a collision avoidance apparatus according to any one of embodiments of the present disclosure;

FIG. 4A-4D are diagrams illustrating a method of generating a virtual lane of an autonomous driving vehicle according to embodiments of the present disclosure;

FIG. 5A-5D are diagrams illustrating a collision avoidance operation by data of a forward vehicle of an autonomous driving vehicle according to an embodiment of the present disclosure;

FIG. 6 is a flowchart illustrating a vehicle collision avoidance method of an autonomous driving vehicle according to an embodiment of the present disclosure;

FIG. 7A-7C are diagrams illustrating a method of generating virtual lanes according to a plurality of forward vehicles of an autonomous driving vehicle according to an embodiment of the present disclosure;

FIG. 8 is a flowchart illustrating a method of generating virtual lanes according to a plurality of forward vehicles of an autonomous driving vehicle shown in FIG. 7;

FIG. 9A-9C are diagrams illustrating a method of generating a virtual lane based on a curvature of a road according to an embodiment of the present disclosure; and

FIGS. 10A and 10B are diagrams illustrating a virtual lane output method according to an embodiment of the present disclosure.

### DETAILED DESCRIPTION

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In the specification, when a part “includes” an element, it means that the part may further include another element rather than excluding another element unless otherwise mentioned.

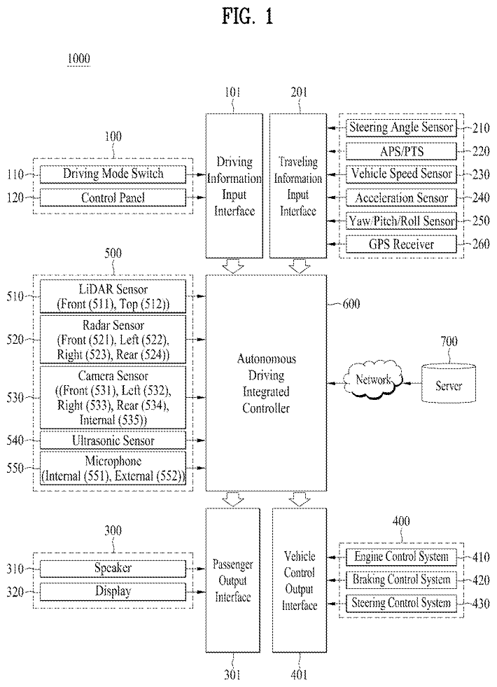

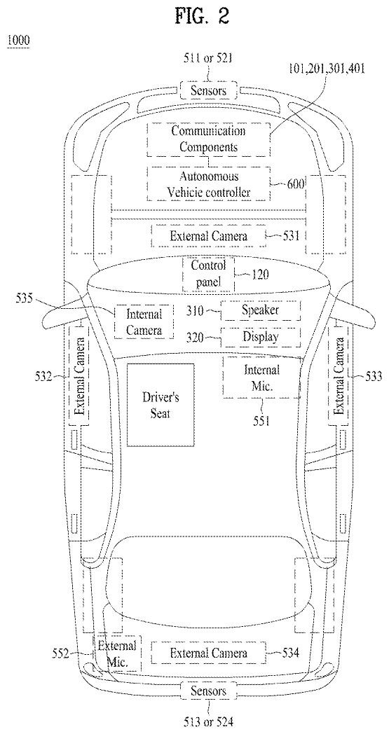

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LiDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

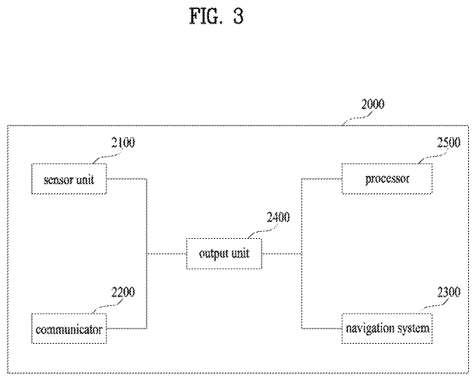

FIG. 3 is a block diagram illustrating a collision avoidance apparatus according to any one of embodiments of the present disclosure.

Referring to FIG. 3, a collision avoidance apparatus 2000 may include a sensor 2100, a communicator 2200, a navigation system 2300, a processor 2400, a vehicle controller 2400, and an output unit 2500.

The sensor unit 2100 may include a camera that captures the front of an autonomous driving vehicle 1000.

The sensor unit 2100 may detect a road, a lane, vehicles, etc., located in front thereof from an image obtained by capturing the front of the autonomous driving vehicle 1000.

The sensor unit 2100 may provide detection information of vehicles located within a predetermined distance in front of the autonomous driving vehicle 1000 to the processor 2400.

The communicator 2200 may communicate with an external vehicle for collision avoidance control of the autonomous driving vehicle 1000 according to the present disclosure. For example, the communicator 2200 may receive GPS information and vehicle specification information from an external vehicle. The communicator 2200 may transmit and receive data with the external vehicle through vehicle-to-vehicle (V2V) communication.

The navigation system 2300 may provide navigation information. The navigation information may include at least one of information about a set destination, route information based on the destination, map information related to a driving route, and information about a current location of a vehicle. The navigation system 2300 may provide information such as a curvature of a road, the number of lanes of the road, and the size of a lane of the road to the processor 2400 as the map information related to a driving route.

The processor 2400 may detect a forward vehicle, that travels on a front road of the autonomous driving vehicle 1000, and a lane of the front road, based on data detected by the camera of the sensor unit 2100.

The processor 2400 may receive GPS information and vehicle specification information of the forward vehicle from the communicator 2200.

The processor 2400 may receive map information of the front road from the navigation system 2300.

Upon failing to detect the lane of the front road, the processor 2400 may generate a virtual vehicle corresponding to the forward vehicle based on the GPS information and the vehicle specification information.

The processor 2400 may generate a virtual lane based on the generated virtual vehicle. Accordingly, the processor 2400 may generate the virtual lane based on the width of a lane in which the virtual vehicle is traveling and the overall width of the virtual vehicle.

In addition, when there is a plurality of forward vehicles, the processor 2400 may receive the GPS information and the vehicle specification information from each of the forward vehicles, thereby generating a plurality of virtual vehicles corresponding respectively to the plurality of forward vehicles. Furthermore, the processor 2400 may generate a plurality of virtual lanes based on the generated plurality of virtual vehicles.

The processor 2400 may determine whether the generated virtual lanes are straight lanes.

When the virtual lanes are straight lanes, the processor 2400 may generate virtual lanes of the entire road by fusing the virtual lanes.

Meanwhile, when some of the virtual lanes are not straight lanes, the processor 2400 may disregard virtual lanes other than straight lanes and fuse virtual lanes except for the disregarded virtual lanes, thereby generating virtual lanes of the entire road.

Then, the processor 2400 may receive information about the curvature of the road from the navigation system 2300. The processor 2400 may generate a virtual lane corresponding to the curvature information.

The processor 2400 may perform control to avoid collision with a forward vehicle based on the generated virtual lane.

The processor 2400 may perform control to generate a hologram based on the generated virtual lane.

The output unit 2500 may output the hologram to the front and rear of the autonomous driving vehicle 1000 based on a control signal generated from the processor 2400.

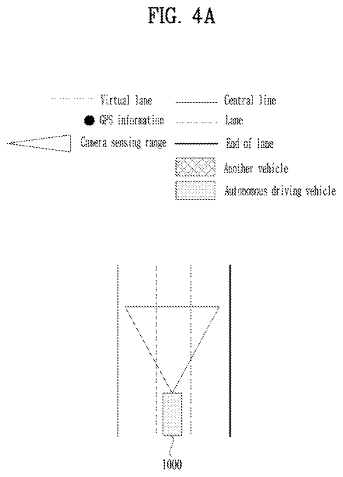

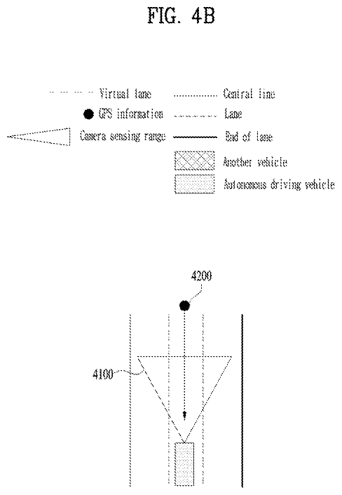

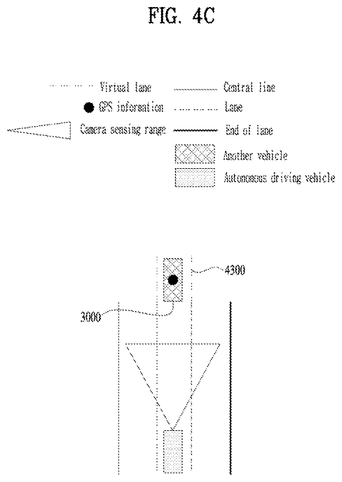

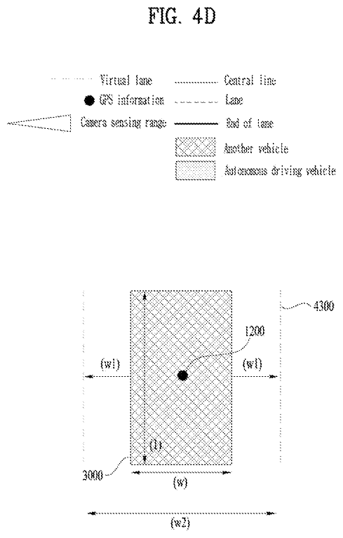

FIG. 4 is a diagram illustrating a method of generating a virtual lane of an autonomous driving vehicle according to embodiments of the present disclosure.

In FIG. 4, an embodiment for solving the case in which an autonomous driving vehicle is incapable of identifying a forward vehicle through an external camera or accurately estimating a front lane is shown.

First, referring to FIG. 4A, a forward vehicle travels in the same direction as the autonomous driving vehicle 1000 and the autonomous driving vehicle 1000 is located behind the forward vehicle, but the forward vehicle and a lane in which the forward vehicle travels are not detected within a detection range 4100 of a front camera of the autonomous driving vehicle 1000.

In this case, as illustrated in FIG. 4B, the autonomous driving vehicle 1000 may receive GPS information 4200 and vehicle specification information from the forward vehicle.

Thereafter, as illustrated in FIG. 4C, the autonomous driving vehicle 1000 may generate a virtual vehicle 3000 based on the GPS information 4200 and the vehicle specification information received from the forward vehicle. In this case, the autonomous driving vehicle 1000 may generate the virtual vehicle 3000 by calculating the entire length 1 and the entire width w of the forward vehicle based on the GPS information.

Thereafter, the autonomous driving vehicle 1000 may generate a virtual lane 4300 based on information about the width of a lane based on the generated virtual vehicle 3000 and navigation information.

That is, the autonomous driving vehicle 1000 may generate the virtual lane 4300 at a distance separated by a preset distance w1 from the left and right of the virtual vehicle 3000. According to an embodiment, the preset distance w1 may be a value obtained by dividing, in half, a difference between a width w2 of the lane and the entire width w of the forward vehicle based on the navigation information.

Accordingly, the autonomous driving vehicle 1000 may perform a collision avoidance control operation through the generated virtual vehicle and virtual lane.

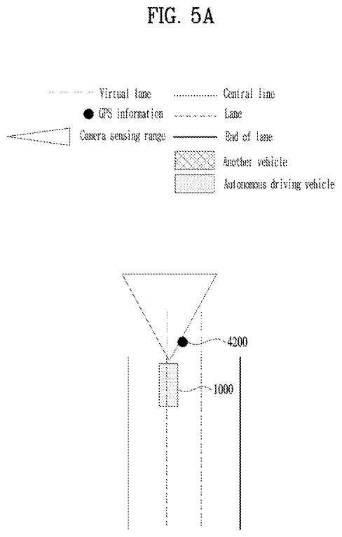

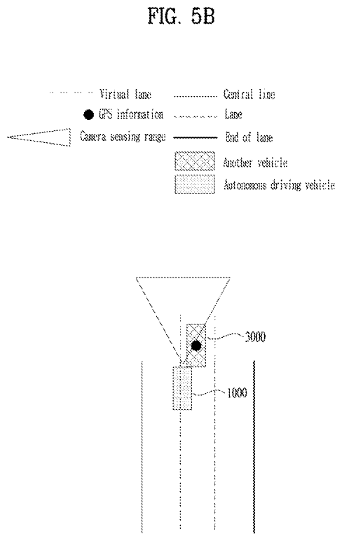

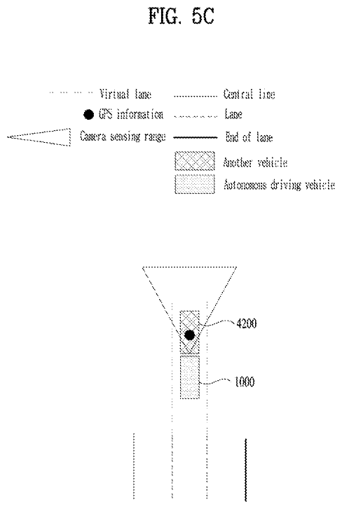

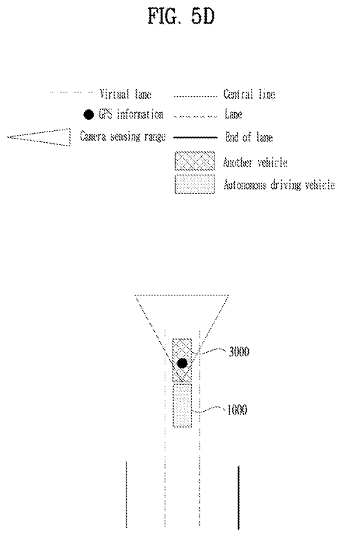

FIG. 5 is a diagram illustrating a collision avoidance operation by data of a forward vehicle of an autonomous driving vehicle according to an embodiment of the present disclosure.

FIG. 5A and FIG. 5B are diagrams illustrating the collision avoidance operation according to lane change of the autonomous driving vehicle 1000.

As illustrated in FIG. 5A, when the autonomous driving vehicle 1000 changes lanes in order to avoid a forward vehicle, it may be determined that the autonomous driving vehicle 1000 does not collide with the forward vehicle based on GPS information of the forward vehicle and on a virtual lane.

However, when collision avoidance is performed using a virtual lane according to the GPS information as illustrated in FIG. 5B, since the entire width of the forward vehicle is not considered, a probability of collision with the forward vehicle may occur.

Accordingly, when the autonomous driving vehicle 1000 performs the collision avoidance operation according to lane change, the autonomous driving vehicle 1000 may prevent collision with the forward vehicle by considering the virtual lane and the virtual vehicle.

Meanwhile, FIG. 5C and FIG. 5D are diagrams illustrating the collision avoidance operation of the autonomous driving vehicle 1000 according to emergency braking of the forward vehicle.

As illustrated in FIG. 5C, when the forward vehicle suddenly brakes, it may be determined that the autonomous driving vehicle 1000 does not collide with the forward vehicle based on the GPS information of the forward vehicle and on the virtual lane.

However, when collision avoidance is performed according to sudden braking of the forward vehicle according to the GPS information as illustrated in FIG. 5(d), since the entire length 1 of the forward vehicle is not considered, a probability of collision with the forward vehicle may occur.

Accordingly, upon performing a collision avoidance operation according to braking of the forward vehicle, the autonomous driving vehicle 1000 may prevent collision with the forward vehicle by considering the entire length 1 of the virtual vehicle.

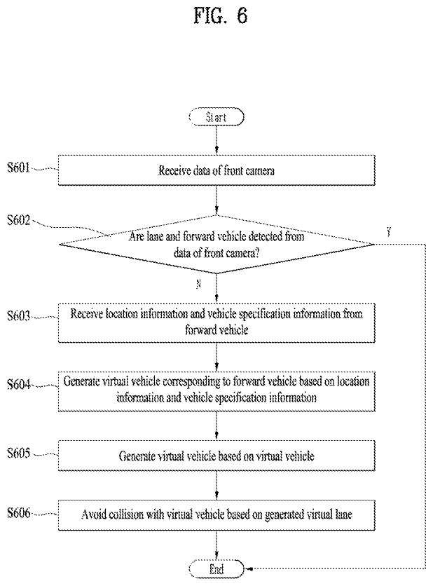

FIG. 6 is a flowchart illustrating a vehicle collision avoidance method of an autonomous driving vehicle according to an embodiment of the present disclosure.

First, the autonomous driving vehicle 1000 according to an embodiment of the present disclosure may acquire front image data from the front camera (S601).

Furthermore, the autonomous driving vehicle 1000 may detect a forward vehicle and a driving lane of the forward vehicle from the image data input through the front camera (S602). The autonomous driving vehicle may detect a forward vehicle and a driving lane of the forward vehicle located within a camera detection range among the image data.

Upon failing to detect the forward vehicle and the traveling lane of the forward vehicle, the autonomous driving vehicle 1000 may receive GPS information and vehicle specification information of the forward vehicle from the forward vehicle (S603). For example, the autonomous driving vehicle 1000 may receive the GPS information and the vehicle specification information from the forward vehicle, and the GPS information may include GPS information of the forward vehicle, and the vehicle specification information may include the entire width and entire length information of the forward vehicle.

After step S603, the autonomous driving vehicle 1000 may generate a virtual vehicle corresponding to the forward vehicle based on the GPS information and the vehicle specification information of the forward vehicle (S604).

The autonomous driving vehicle may generate a virtual lane in which the virtual vehicle 2000 travels based on the virtual vehicle generated in step S604 and navigation information (S605).

The autonomous driving vehicle 1000 may perform collision avoidance control with the virtual vehicle based on the virtual lane generated in step S605 and the virtual vehicle (S606). Accordingly, in a collision avoidance control situation of the autonomous driving vehicle 1000, a possibility of collision may be avoided through the virtual vehicle. This may correspond to, for example, FIG. 5 described above.

That is, the technical idea of the present disclosure may be applied to the whole autonomous driving vehicle or may be applied to only some configurations inside the autonomous driving vehicle. The scope of the present disclosure should be determined according to the matters described in the claims.

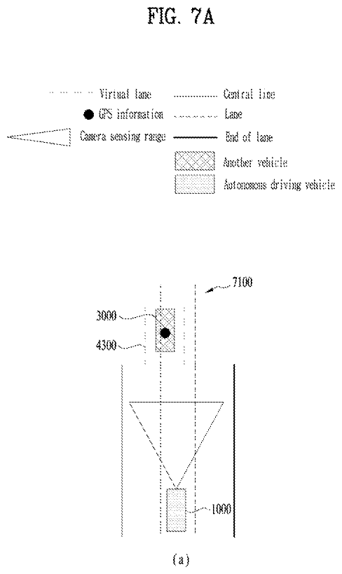

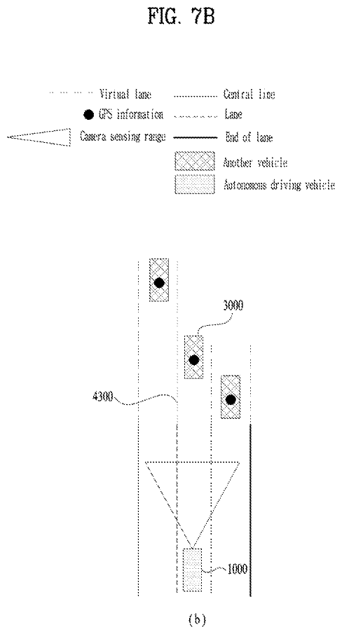

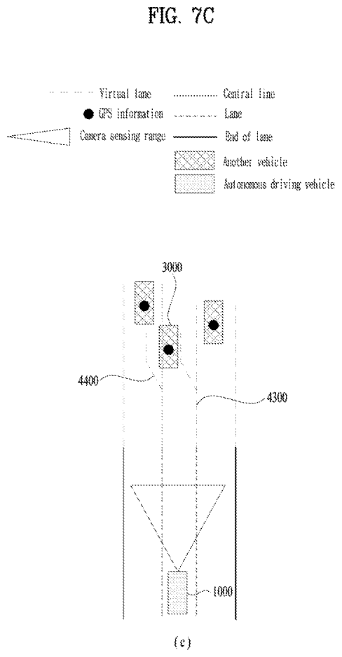

FIG. 7 is a diagram illustrating a method of generating virtual lanes according to a plurality of forward vehicles of an autonomous driving vehicle according to an embodiment of the present disclosure.

First, FIG. 7A is a diagram illustrating a virtual vehicle and a virtual lane generated by data received from one forward vehicle of the autonomous driving vehicle 1000.

As illustrated in FIG. 7A, when the autonomous driving vehicle 1000 generates a virtual lane by one forward vehicle, the virtual lane different from an actual lane may be generated. For this reason, there is a risk of the autonomous driving vehicle 1000 traveling in a lane different from the actual lane.

Accordingly, accuracy of the autonomous driving vehicle is lowered in that the virtual lane generated only by data of one forward vehicle does not match the actual lane, and thus there is a risk that the autonomous driving vehicle 1000 travels in a lane different from the actual lane during the collision prevention operation.

Accordingly, the autonomous driving vehicle 1000 needs to perform a method of increasing the reliability of a virtual lane through a plurality of forward vehicles as illustrated in FIG. 6B and FIG. 6C.

FIG. 7B illustrates the case in which the autonomous driving vehicle 1000 generates virtual lanes based on data of a plurality of forward vehicles when the forward vehicles well maintain straight lines of an actual road.

The autonomous driving vehicle 1000 may generate virtual lanes of the entire road by combining the generated virtual lanes. Therethrough, the reliability of the autonomous driving vehicle 1000 may be raised.

According to an embodiment, when three vehicles are driving in front of the autonomous driving vehicle 1000 which is traveling on a three-lane straight road, the autonomous driving vehicle 1000 may generate a first virtual lane corresponding to a forward vehicle traveling in the first lane, a second virtual lane corresponding to a forward vehicle traveling in the second lane, and a third virtual lane corresponding to a forward vehicle driving in the third lane.

Thereafter, the autonomous driving vehicle 1000 may generate virtual lanes of the entire three-lane road by substituting the generated first to third virtual lanes into the road on which the autonomous driving vehicle 1000 is currently traveling.

Meanwhile, FIG. 7C illustrates the case in which the autonomous driving vehicle 1000 generates virtual lanes based on data of a plurality of forward vehicles when some of the forward vehicles do not maintain straight lines of an actual road.

The autonomous driving vehicle 1000 may generate virtual lanes of the entire road based on forward vehicles of the autonomous driving vehicle 1000. In this case, when there is a difference in lane information by comparing the generated virtual lanes, the autonomous driving vehicle 1000 may select virtual lanes generated based on more vehicles among a plurality of vehicles as driving lanes and travel in the driving lanes.

According to an embodiment, when three vehicles in front of the autonomous driving vehicle 1000 traveling in a lane on the road are traveling in respective lanes, the autonomous driving vehicle 1000 may generate a first virtual lane corresponding to the forward vehicle traveling in the first lane, a second virtual lane corresponding to the forward vehicle traveling in the second lane, and a third virtual lane corresponding to the forward vehicle traveling in the third lane.

In this case, the first virtual lane and the third virtual lane may be virtual lanes corresponding to straight lanes of the road, and the second virtual lane may be a virtual lane which does not correspond to a straight lane of the road.

When it is determined that the second virtual lane does not correspond to the straight lane, the autonomous driving vehicle 1000 may disregard data of the forward vehicle corresponding to the second virtual lane and generate virtual lanes of the entire road based on the first virtual lane and the third virtual lane.

Thereafter, the autonomous driving vehicle 1000 may autonomously travel by determining that the virtual lanes of the entire road implemented by the second virtual lane and the third virtual lane are actual lanes.

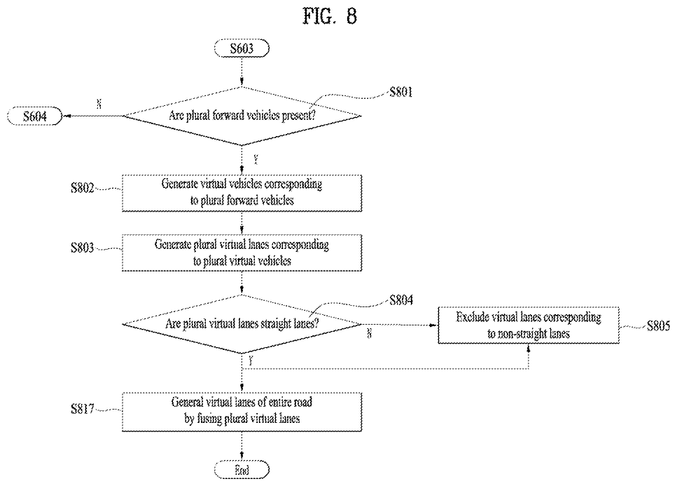

FIG. 8 is a flowchart illustrating a method of generating virtual lanes according to a plurality of forward vehicles of an autonomous driving vehicle shown in FIG. 7.

Referring to FIG. 8, the autonomous driving vehicle 1000 according to an embodiment of the present disclosure may receive GPS information and vehicle specification information from a forward vehicle. The autonomous driving vehicle 1000 may determine whether a plurality of forward vehicles is present (S801).

As a result of the determination, when there is a plurality of forward vehicles, the autonomous driving vehicle 1000 may generate virtual vehicles corresponding to the plural forward vehicles (S802).

The autonomous driving vehicle 1000 may generate a plurality of virtual lanes corresponding to a plurality of virtual vehicles (S803).

The autonomous driving vehicle 1000 may determine whether the plural virtual lanes are straight lanes (S804).

When the virtual lanes are not necessarily straight lanes in S804, the autonomous driving vehicle 1000 may exclude virtual lanes corresponding to non-straight lanes (S805).

The autonomous driving vehicle 1000 may generate virtual lanes of the entire road by fusing a plurality of virtual lanes (S806). Accordingly, when there is a difference in lane information by comparing the generated virtual lanes, the autonomous driving vehicle 1000 may generate the virtual lanes of the entire road generated based on more virtual vehicles among a plurality of virtual vehicles.

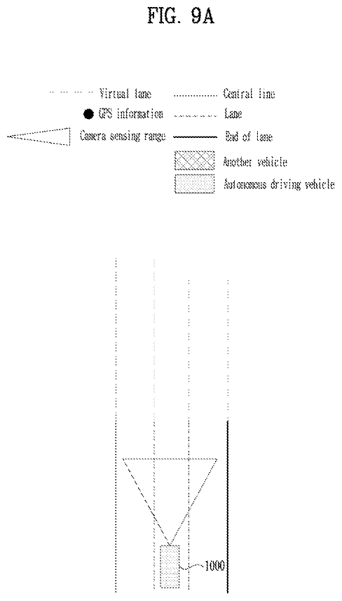

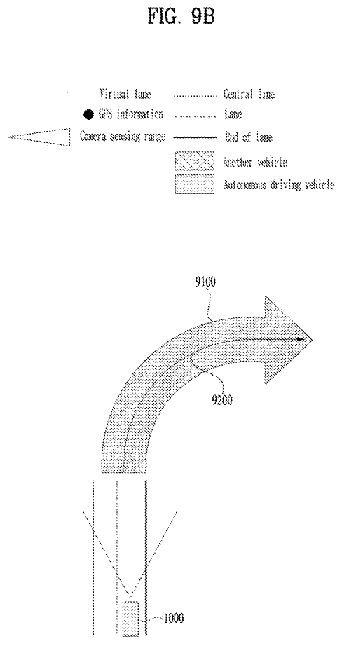

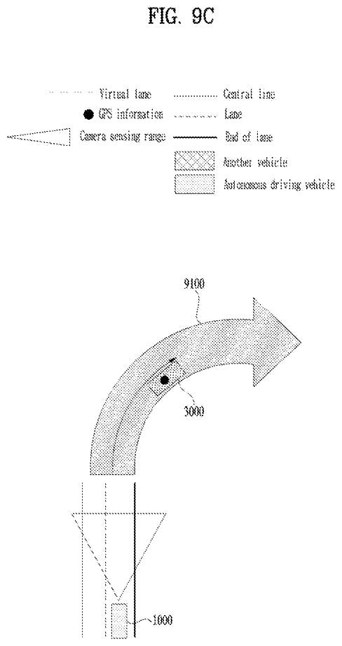

FIG. 9 is a diagram illustrating a method of generating a virtual lane based on a curvature of a road according to an embodiment of the present disclosure.

The autonomous driving vehicle 1000 may generate a virtual lane by applying a curvature of a road on which the autonomous driving vehicle 1000 is currently traveling. In addition, the autonomous driving vehicle 1000 may increase the accuracy of the virtual lane by receiving the motion data of a forward vehicle.

FIG. 9A is a diagram illustrating the case in which the curvature of the road on which the autonomous driving vehicle 1000 is currently traveling is 0.

The autonomous driving vehicle 1000 may generate a virtual lane in front thereof based on the location of a lane in which the autonomous driving vehicle 1000 is currently traveling.

Meanwhile, FIG. 9B and FIG. 9C are diagrams illustrating the case in which the curvature of a front road on which the autonomous driving vehicle 1000 is currently traveling is not zero.

As illustrated in FIG. 9B, the autonomous driving vehicle 1000 may generate an estimated virtual lane 9200 based on curvature information 9100 of the road on which the autonomous driving vehicle 1000 is currently traveling through navigation information.

Thereafter, as illustrated in FIG. 9C, the autonomous driving vehicle 1000 may generate a final virtual lane 4300 by fusing the estimated virtual lane information implemented through the navigation information with virtual lane data generated by an actual forward vehicle.

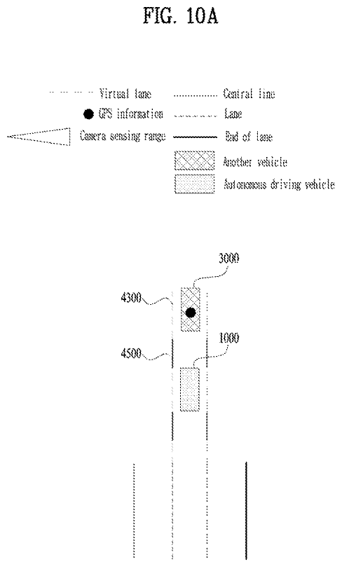

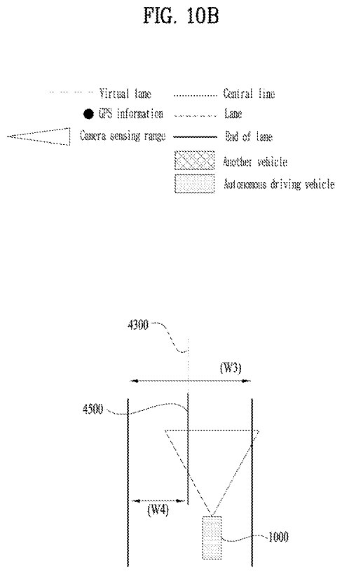

FIG. 10 is a diagram illustrating a virtual lane output method according to an embodiment of the present disclosure.

FIG. 10A illustrates the case in which an autonomous driving vehicle maintains an autonomous driving operation based on a virtual lane implemented based on a forward vehicle.

The autonomous driving vehicle 1000 may output a virtual lane 4300 generated by a forward vehicle through a hologram 4500 to the front and rear thereof. In this case, the hologram 4500 may be output at the same position as the virtual lane 4300. In addition, the hologram 4500 may be output in the same form as the virtual lane 4300.

For example, the autonomous driving vehicle 1000 may visually provide the hologram 4500 according to the virtual lane 4300 to the driver thereof.

For example, the autonomous driving vehicle 1000 may visually provide lane information to a backward vehicle through the hologram according to the virtual lane 4300. Accordingly, collision with a vehicle approaching from the rear of the autonomous driving vehicle may be avoided.

FIG. 10B is a diagram illustrating the case in which the autonomous driving vehicle travels on a road having no lanes.

The autonomous driving vehicle 1000 may detect a driving lane of a forward vehicle located within a camera detection range among image data.

Upon failing to detect the driving lane of the road, the autonomous driving vehicle 1000 may receive information about the width of the entire road from the navigation system 2300.

The autonomous driving vehicle 1000 may generate a virtual lane based on the received information about the width of the entire road. To this end, the autonomous driving vehicle 1000 may generate a virtual lane 4300 corresponding to a central line by dividing the width of the entire road by 2.

Thereafter, the autonomous driving vehicle 1000 should be capable of avoiding collision with the forward vehicle and have no problems in safe driving even with respect to an opposite vehicle. For this purpose, the autonomous driving vehicle 1000 needs to consider all of a width W3 of an actual road, a width W4 of the virtual lane, and the entire width of the opposite vehicle.

Thereafter, the autonomous driving vehicle 1000 may output the generated virtual lane 4300 through a hologram 4500.

Therefore, even on road on which lanes are not detected, there is an advantage of eliminating the possibility of collision between the autonomous driving vehicle and the opposite vehicle while securing the central line so that a nearby vehicle may move.

As another aspect of the present disclosure, the above-described proposal or operation of the disclosure may be provided as code which may be implemented, carried out, or executed by a “computer” (comprehensive concept including a system-on-chip (SoC) or a microprocessor) or as an application, a computer-readable storage medium, or a computer program product, which stores or includes the code, and this also falls within the scope of the present disclosure.

As described above, the detailed description of the embodiments of the present disclosure has been given to enable those skilled in the art to implement and practice the disclosure. Although the disclosure has been described with reference to the embodiments, those skilled in the art will appreciate that various modifications and variations may be made in the present disclosure without departing from the spirit or scope of the disclosure and the appended claims. For example, those skilled in the art may use constructions disclosed in the above-described embodiments in combination with each other.

Accordingly, the present disclosure should not be limited to the specific embodiments described herein, but should be accorded the broadest scope consistent with the principles and features disclosed herein.

Various implementations of the apparatus, system, unit, controller, and processor described herein may include digital electronic circuits, integrated circuits, field programmable gate arrays (FPGAs), application specific integrated circuits (ASICs), computer hardware, firmware, software, and/or a combination thereof. These various implementations may include an implementation using one or more computer programs executable on a programmable system. The programmable system includes at least one programmable processor (which may be a special purpose processor or a general-purpose processor) coupled to receive and transmit data and instructions from and to a storage system, at least one input device, and at least one output device. Computer programs (also known as programs, software, software applications or codes) contain instructions for a programmable processor and are stored in a computer-readable recording medium.

What is claimed is:

1. A collision avoidance method, comprising:
sensing, by a sensor, a forward vehicle and a lane of a front road;
receiving, by a communicator, global positioning system (GPS) information and vehicle specification information from the forward vehicle;
upon failing to detect the lane of the front road, generating, by a processor, a virtual lane corresponding to the forward vehicle; and
performing, by the processor, a control operation to avoid collision with the forward vehicle based on the generated virtual lane.

2. The collision avoidance method of claim 1, wherein the generating the virtual lane corresponding to the forward vehicle comprises:
upon failing to detect the lane of the front road, generating, by the processor, a virtual vehicle corresponding to the forward vehicle based on the GPS information and the vehicle specification information; and
generating, by the processor, the virtual lane based on the generated virtual vehicle.

3. The collision avoidance method of claim 2, wherein the generating the virtual lane based on the generated virtual vehicle comprises:
generating, by the processor, the virtual lane based on a width of a lane in which the virtual vehicle is traveling and an entire width of the virtual vehicle.

4. The collision avoidance method of claim 2, further comprising:
receiving, by the processor, the GPS information and the vehicle specification information from each of a plurality of forward vehicles based on presence of the plurality of forward vehicles;
generating, by the processor, a plurality of virtual vehicles corresponding to the plurality of forward vehicles, respectively; and
generating, by the processor, a plurality of virtual lanes corresponding to the plurality of generated virtual vehicles, respectively.

5. The collision avoidance method of claim 4, further comprising determining, by the processor, whether the plurality of virtual lanes are straight lanes.

6. The collision avoidance method of claim 5, further comprising generating, by the processor, virtual lanes of an entire road by fusing the plurality of virtual lanes, based on the plurality of virtual lanes being the straight lanes.

7. The collision avoidance method of claim 5, further comprising:
disregarding, by the processor, non-straight virtual lanes when some of the plurality of virtual lanes are not straight lanes; and
generating, by the processor, virtual lanes of an entire road by fusing a plurality of virtual lanes except for the disregarded virtual lanes.

8. The collision avoidance method of claim 2, further comprising:
receiving, by the processor, curvature information of the front road; and
generating, by the processor, the virtual lane in correspondence to the curvature information.

9. The collision avoidance method of claim 1, further comprising:
generating, by the processor, a hologram based on the generated virtual lane; and
outputting, by an output unit, the generated hologram to a front and a rear of a vehicle.

10. A recording medium storing a collision avoidance program that causes a computer to
sense a forward vehicle and a lane of a front road,
receive global positioning system (GPS) information and vehicle specification information from the forward vehicle,
upon failing to detect the lane of the front road, generate a virtual lane corresponding to the forward vehicle, and
perform a control operation to avoid collision with the forward vehicle based on the generated virtual lane.

11. A collision avoidance apparatus, comprising:
a sensor configured to sense a forward vehicle and a lane of a front road;
a communicator configured to receive global positioning system (GPS) information and vehicle specification information from the forward vehicle;
a navigation system configured to provide map information of the front road; and
a processor configured to generate a virtual lane corresponding to the forward vehicle, upon failing to detect the lane of the front road, and perform a control operation to avoid collision with the forward vehicle based on the generated virtual lane.

12. The collision avoidance apparatus of claim 11, wherein the processor
generates a virtual vehicle corresponding to the forward vehicle based on the GPS information and the vehicle specification information upon failing to detect the lane of the front road, and
generates the virtual lane based on the generated virtual vehicle.

13. The collision avoidance apparatus of claim 12, wherein the processor generates the virtual lane based on a width of a lane in which the virtual vehicle is traveling and an entire width of the virtual vehicle.

14. The collision avoidance apparatus of claim 12, wherein the communicator
receives the GPS information and the vehicle specification information from each of a plurality of forward vehicles based on presence of the plurality of forward vehicles,
wherein the processor generates a plurality of virtual vehicles corresponding to the plurality of forward vehicles, respectively, and
generates a plurality of virtual lanes corresponding to the plurality of generated virtual vehicles, respectively.

15. The collision avoidance apparatus of claim 14, wherein the processor determines whether the plurality of virtual lanes are straight lanes.

16. The collision avoidance apparatus of claim 15, wherein the processor generates virtual lanes of an entire road by fusing the plurality of virtual lanes, based on the plurality of virtual lanes being the straight lanes.

17. The collision avoidance apparatus of claim 15, wherein the processor
disregards non-straight virtual lanes when some of the plurality of virtual lanes are not the straight lanes, and
generates virtual lanes of an entire road by fusing a plurality of virtual lanes except for the disregarded virtual lanes.

18. The collision avoidance apparatus of claim 12, wherein the processor
receives curvature information of the front road from the navigation system, and
generates the virtual lane in correspondence to the curvature information.

19. The collision avoidance apparatus of claim 11, wherein the processor
generates a hologram based on the generated virtual lane, and
performs the control operation to output the generated hologram to a front and a rear of a vehicle.

20. An autonomous driving vehicle, comprising:
at least one sensor configured to sense a forward vehicle and a lane of a front road; and
a collision avoidance apparatus configured to generate a virtual lane corresponding to the forward vehicle, upon failing to detect the lane of the front road, and perform a control operation to avoid collision with the forward vehicle based on the generated virtual lane.
